(19) United States
(12) Patent Application Publication
(10) Pub. No.: US 2009/0261052 A1
(43) Pub. Date: Oct. 22, 2009

(54) Method and Apparatus for Deep Water Deployment Operations

(75) Inventor: Knut Vasstrand, Blommenholm (NO)

Correspondence Address: MYERS BIGEL SIBLEY & SAJOVEC, PO BOX 37428, RALEIGH, NC, 27627, US

(73) Assignee: Aker Marine Contractors AS

(21) Appl. No.: 12/428,175

(22) Filed: Apr. 22, 2009

(30) Foreign Application Priority Data
Apr. 22, 2008 (NO) 20081906

(51) Int. Cl. B66C 13/06; B66C 23/60

(52) U.S. Cl. 212/270; 212/311

(57) ABSTRACT

A method of deploying an object (14) onto the seabed in very deep water from a vessel having a heave compensated deck crane (12), comprises lowering the object a distance into the sea while being suspended in the crane wire (16).

In an initial step, a first fibre rope section (4a) of a first length is connected to the object (14) via a first connector (3a) on the object before the lowering is started and is freely run out supporting from a storage reel (13) during the descent. Subsequently, the first rope section is the object via a second connector (3b) located at the upper end of the first rope section (4a), the second connector being supported by a support mechanism (1) on the vessel deck (8), followed by off-loading the crane wire (16) and disconnecting it from the object and heaving it up said first length for connection to the second connector (3b) at the vessel deck and taking over the load of the object. Next, the object (14) is lowered a second length into the water by the crane while a second rope section (4b) connected to the second connector is freely run out from a storage reel (13) until a third connector (3c) located at the upper end of the second rope supports the load of the object in the support mechanism (1), whereupon the crane hook can be released and be brought up for re-connection to the third connector (3c) for the subsequent deployment, and any further deployment by addition to the string of ropes, thereby allowing the object (14) to reach a depth of up to 3000 meter, or even more.

### RELATED APPLICATION

This application claims the benefit of Norwegian Patent Application No. 20081906, filed on Apr. 22, 2008, in the Norwegian Patent Office, the disclosure of which is incorporated herein in its entirety by reference.

### FIELD OF THE INVENTION

The present invention relates to equipment and a method of deploying an object on the seabed that is part of the infrastructure in oil and gas field located in very deep water, i.e. more than 1000 meter.

### BACKGROUND

Conventional offshore installation methods are normally based on lifting the object onto the seabed with a crane construction. Such operations set high demands to crane capacity and can be very weather sensitive operations. For very deep water installation, i.e. more than 1000 meter of water depth, the weight of the crane wire starts affecting and reducing and/or minimizing the pay-load of the crane.

### SUMMARY

The present invention is presenting a method on how this reduction of payload can be avoided, the method being defined in claim 1. The invention also comprises an apparatus as defined in claim 4.

Also, when a passive heave compensating is applied in certain areas with extreme sea-swell conditions, the support mechanism may be simplified as the roundel may be connected directly between the line from heave compensator and the rope-section carrying the object when the crane hook is disconnected for preparation of the next lowering-step making the cradle obsolete in these instances.

The passive heave compensating system when introduced also lends itself to connect a winch to this system allowing the object to be lowered onto seabed by the winch via the passive heave compensator as an alternative to lowering on the crane for the last lowering step.

In order to avoid the crane wire affecting the payload at deep water, the usage of the crane wire is proposed limited to typically 1000 meter water depth, and fibre rope is instead introduced for further depths to be reached. Fibre rope can have a specific weight of 0.97-1.4, depending of type of rope, and is as such close to neutral in water, with no or a reduced and/or minimum effect on crane load. The fibre ropes have generally a strength superior of steel and stiffness close to steel for the preferred ropes for this service, thus having behaviour under load not deviating much from that of a steel wire.

The present invention is presenting a method on how this reduction of payload can be avoided, the method being defined in claim 1. The invention also comprises an apparatus as defined in claim 4.

In this method, when deploying the object by the crane from the deck of a vessel, the crane wire is proposed used for the first 1000 meter of deployment. However, a first fibre rope section is also connected to the object via a roundel on the lifting slings and is freely unreeled from a storage reel until the object is reaching 1000 meter of water depth.

At 1000 meter of water depth, the first fibre rope section takes over the load of the object and supports it from a support mechanism located on the edge of the vessel deck. The support mechanism consists of a support-cradle supporting a roundel connected to the end of the fibre rope. The crane wire hook is disconnected from the object by a ROV and heaved up to above the deck level.

The crane wire hook is then once again connected onto the object via connection to a roundel at top end of the first suspended fibre rope, followed by a descent of the object suspended on the crane wire and rope another 1000 meter down to 2000 meter of water depth. A second fibre rope section on the storage reel is connected to the object via the roundel on top of the first rope section and freely unreeled until the object is reaching this water depth.

At 2000 meter of water depth, the fibre ropes takes over the load and supports the object from the support mechanism located on the edge of the vessel deck. The crane wire hook is disconnected from the object by a ROV and heaved up to above the deck level.

The crane wire hook is then once again connected onto the object via connection to a roundel at the top end of the second fibre rope section, followed by a descent of the object suspended on the crane wire and ropes another 1000 meter down to 3000 meter of water depth.

For landing the object onto the seabed, the active heave compensating system on the crane will be activated for the last 100 meter. This may reduce and/or minimize the impact onto the object during the actual landing.

For installation in certain areas of the world, typically West Africa, sea swell might be present. For these areas, a passive heave compensating system is introduced into the support mechanism on the edge of the vessel deck for a short period of intermediate support of the object when it is suspended by fibre ropes while the crane hook is disconnected.

### BRIEF DESCRIPTION OF THE DRAWINGS

The present invention shall be described in the following with a reference to the is attached drawings which illustrate a preferred embodiment, wherein:

FIG. 1 is showing front and side elevations and a section through the support mechanism comprising a hang-off cradle capable to support roundel plates that are connecting 1000 meter rope section. The support mechanism is located on a structural grillage on the edge of the vessel deck underneath the deck crane.

FIG. 2 is a transverse section of the vessel, showing the start of the first sequence of the deployment operation, with the crane launching the object from deck of the vessel onto the first 1000 meter of deployment with the rope connected to the roundel at the object slings, the rope being freely unreeled from a deck storage reel capable of storing two separate rope sections, each 1000 meter of length. The support mechanism is indicated on the edge of the vessel deck.

FIG. 3 is a transverse section of the vessel, showing the first sequence completed, with the object suspended in the first 1000 meter of rope section from the support mechanism on the edge of the vessel deck, and crane hook disconnected from the object and heaved up. The second 1000 meter rope section rests on the storage reel ready to be pulled out for connection to the first rope section.

FIG. 4 is a transverse section of the vessel, showing the second sequence of the deployment operation, with crane hook connected to the roundel at top of the first rope section and the object being lowered the next 1000 meter, while the second rope section has been connected to the same top of first rope section and being freely unreeled from the deck storage reel.

FIG. 5 is a transverse section of the vessel, showing the second sequence completed with the object suspended in the two first 1000 meter rope sections from the support mechanism on the edge of the vessel deck, and the crane hook having been disconnected from the object and heaved up. The deck storage reel is now empty.

FIG. 6 is a transverse section of the vessel, showing the third sequence of the deployment operation, with the crane hook connected to the top of the second rope section and the object being lowered the last 1000 meter to the seabed.

FIG. 7 is a side and a front elevation drawing of the support mechanism, showing an elevator tower introduced when needed under special sea swell conditions, allowing a passive heave compensator to be connected to the hang-off cradle whenever the roundel with the object load is supported in the cradle.

FIG. 8 is side and front elevation drawings and an enlarged detail of the support mechanism with the main item now being the elevator tower shown in FIG. 7 but without the cradle. This arrangement is introduced when needed under special sea swell condition and is allowing the roundel to be connected directly between the heave compensator and the rope section carrying the object. A detachable access platform on the roundel is arranged for ease of the rigging work on the roundel.

### DETAILED DESCRIPTION OF THE PREFERRED EMBODIMENT

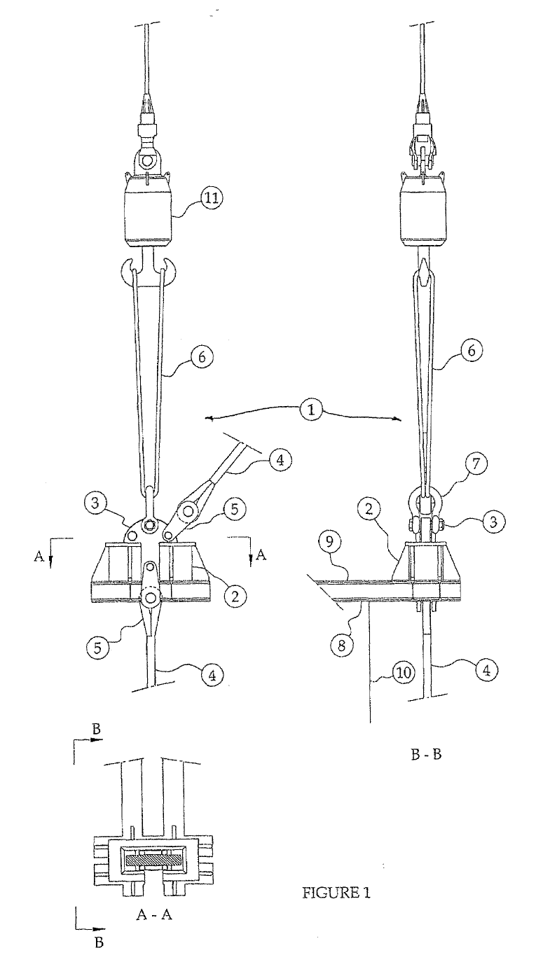

FIG. 1 is showing the support mechanism 1 made up by a hang-off cradle 2 supporting the roundel plate 3 that is connecting the 1000 meter rope sections 4. The roundel 3 has a number of holes in the circumference for rope and crane hook connections via rope thimbles 5 and shackles 7.

The hang-off cradle has a vertical cut in the side plate, allowing the rope 4 to enter sideways into the hang-off cradle 2 and the roundel 3 to be lowered into the cradle for support.

The fibre ropes 4 are connected to the roundel 3 by a thimble 5, and the crane hook 11 is connected to the same by a grommet 6 and shackle 7.

The hang-off cradle 2 is supported on the edge of the vessel deck 8 by a structural grillage 9 cantilevered on the vessel side 10.

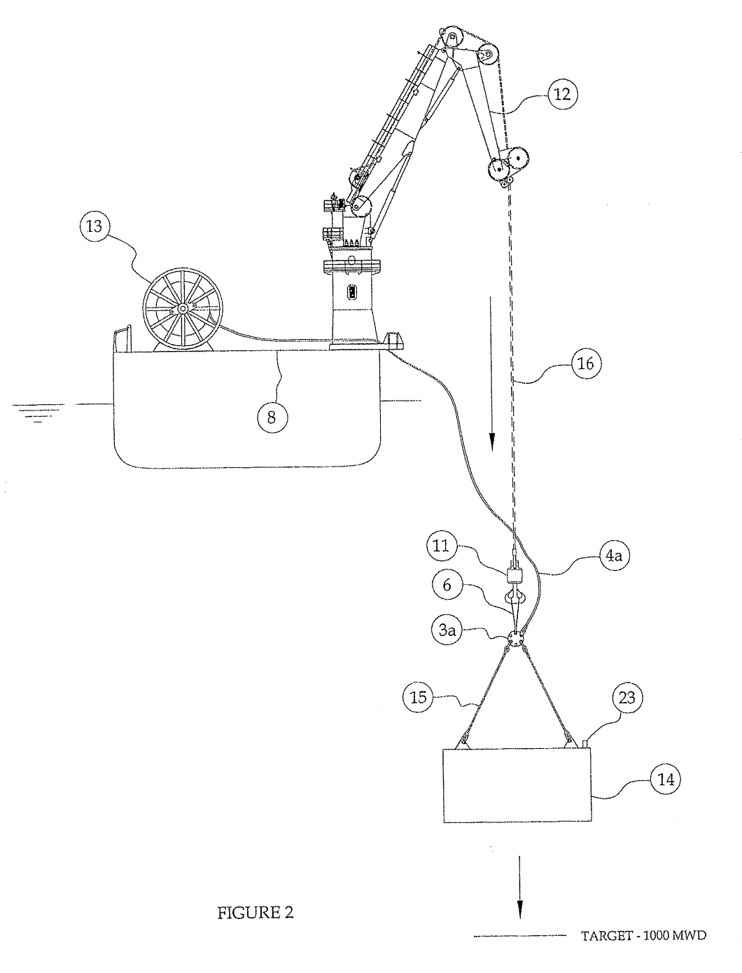

FIG. 2 is showing the execution of the first sequence of deployment operation, with the object 14 with slings 15 and associated first roundel 3a being lowered down the first 1000 meter of the water depth on the crane wire 16 with the crane hook 11 and the crane boom 12, while the first 1000 meter of fibre rope section 4a connected to the first roundel 3a is freely run out from the storage reel 13 located on the vessel deck 8.

The object 14, being a structure or process unit, is suspended from the roundel 3a by slings with shackles 15.

The rope storage reel 13 is capable of storing typically two 1000 meter rope sections.

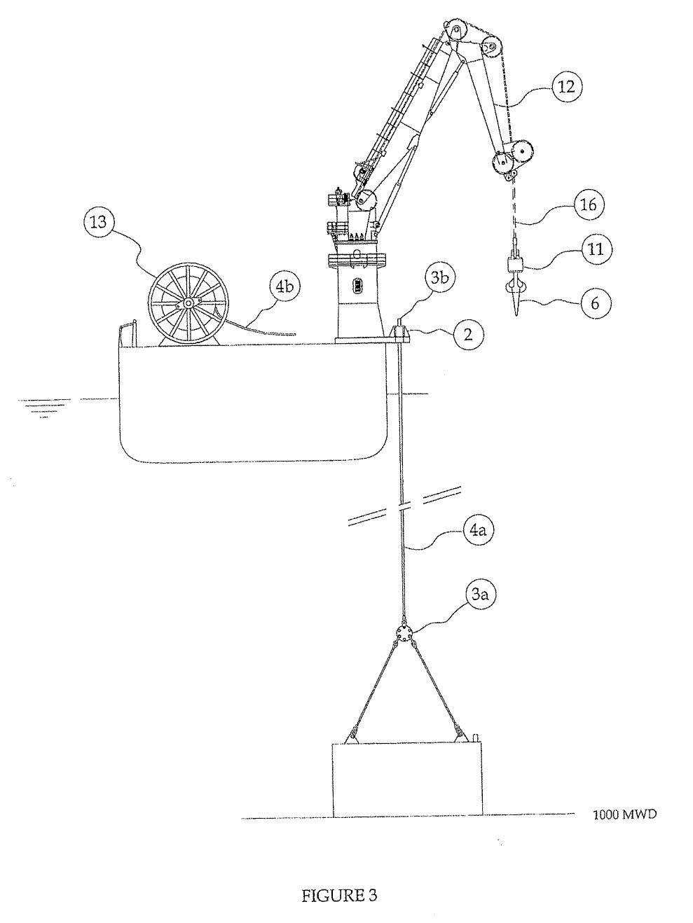

The execution of the first sequence of the deployment operation is shown completed in FIG. 3, where lowering of the first 1000 meter of fibre rope section 4a has ended and been supported in the cradle 2 by landing the second roundel 3b, which has been connected to the first rope section, into it. The crane hook 11 and grommet 6 are disconnected from the first roundel 3a and heaved up and located beneath the crane boom 12. The second fibre rope section 4b remains on the storage reel 13, ready to be pulled out and connected via the second roundel 3b to the first rope section 4a.

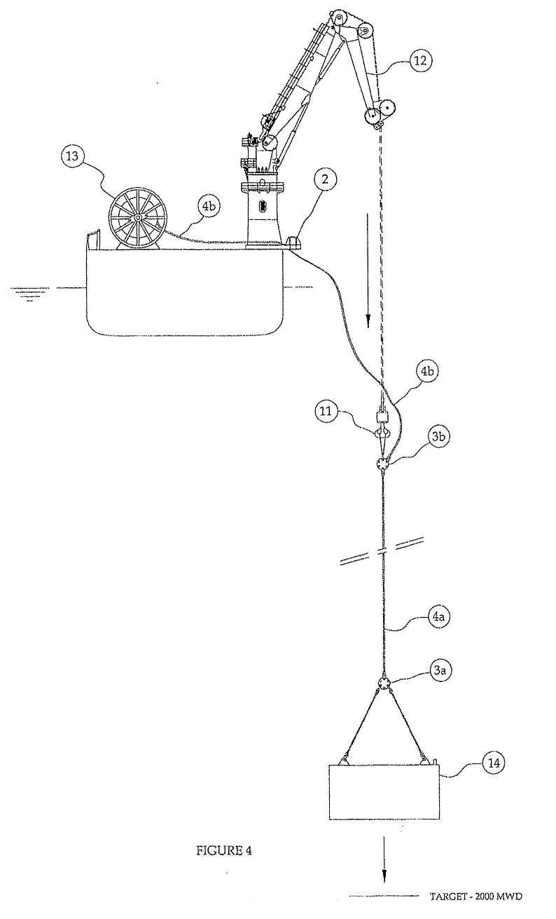

FIG. 4 is showing the execution of the second sequence of the deployment operation, with the crane hook 11 connected to the second roundel 3b on top of the first rope section 4a, by lowering the object 14 the next 1000 meter while the second rope section 4b is connected to the same roundel 3b and is freely unreeled from the deck storage reel 13. The object 14 will then reach a depth of 2000 meter.

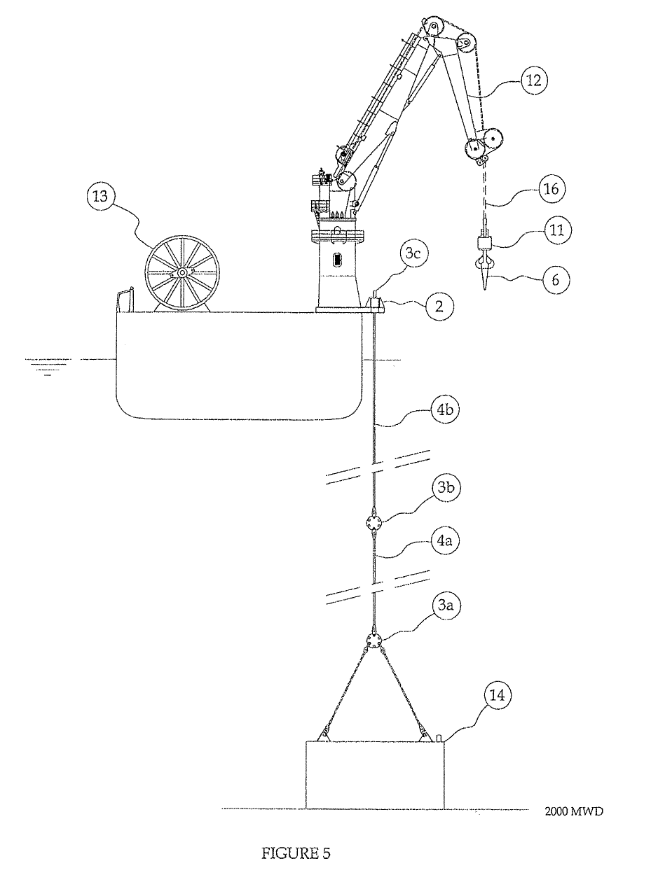

FIG. 5 is showing the second sequence of the deployment when completed, with the object 14 suspended in the two first 1000 meter rope sections 4a and 4b from the support mechanism on the edge of the vessel deck 8, and with the crane hook 11 disconnected from the object 14 and heaved up. Deck storage reel 13 is now empty.

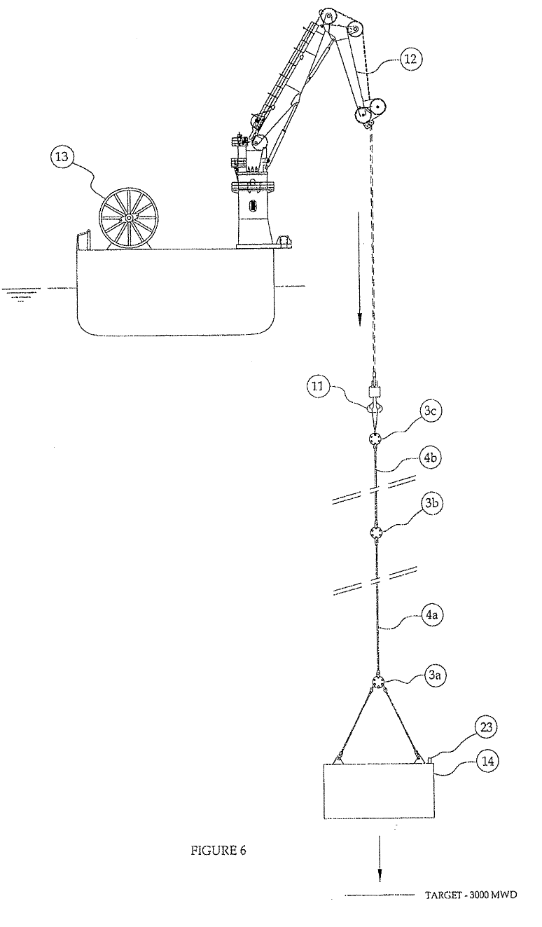

FIG. 6 is showing the execution of the third sequence of the deployment operation, with the crane hook 11 connected to the third roundel 3c on top of the second rope section 4b, by lowering the object 14 the last 1000 meter to the seabed. The object 14 will then reach a depth of 3000 meter.

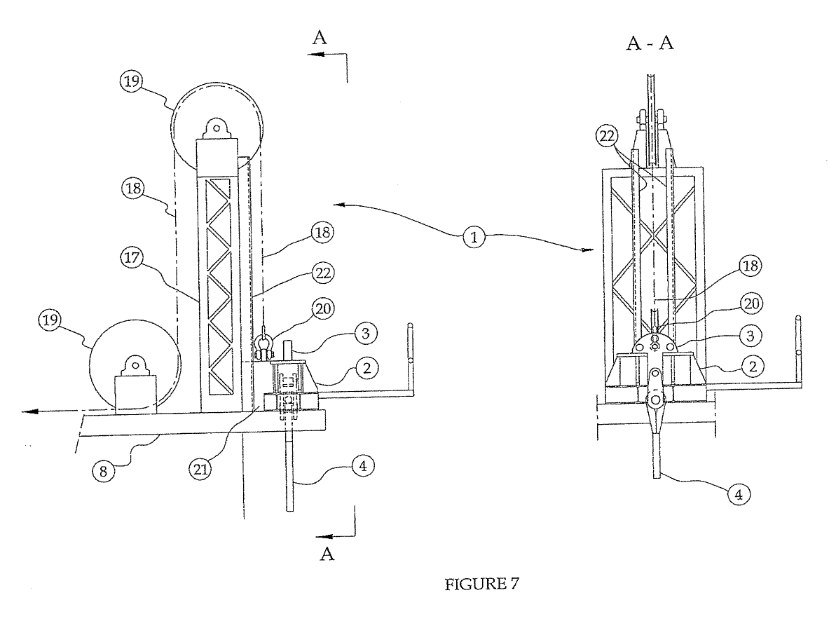

FIG. 7 is side and front elevation drawings of the support mechanism 1, showing an elevator tower 17 introduced whenever needed under special sea swell condition, allowing a passive heave compensator (not shown) to be connected to the hang-off cradle 2 whenever the roundel 3 with the object load is supported in the cradle. The passive heave compensator is connected to the cradle via a shackle 20 and a wire line 18 running on sheaves 19. The cradle is fitted with a guide shoe 21, allowing the assembly to run vertically along the elevator-guide 22 with a typical stroke of 2-3 meter.

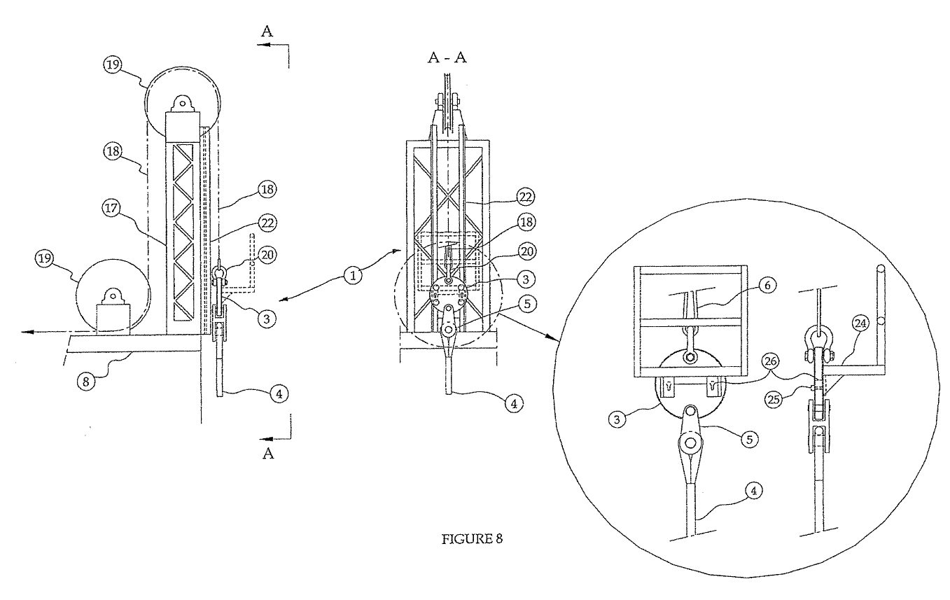

FIG. 8 is side and front elevation drawings and an enlarged detail of the support mechanism 1 with the main item now being an elevator tower 17 but without the cradle. Whenever special sea swell condition requires passive heave compensating, this arrangement allows a roundel 3 to be connected directly between a passive heave compensator (not shown) and a rope section 4, without the support of any cradle 2. The passive heave compensator is connected to the roundel via a shackle 20 and a wire line 18 running on sheaves 19 onto the passive heave compensator and possibly also a winch, if required. The roundel will run vertically along the elevator-guide 22, allowing a stroke of typical 2-3 meter. An access platform 24 shown stippled is connected to the roundel 3 to ease the access for rigging work on the roundel. The platform is made detachable by a double key 25 and key-hole 26 locking mechanism, as indicated on the roundel 3. A small auxiliary crane will probably be adequate to assist rigging personnel in the re-rigging of the roundel for each new lowering step.

1. A method of deploying an object (14) onto the seabed in very deep water from a vessel having a heave compensated crane (12), comprising lowering the object a distance into the sea while being suspended in the crane wire (16),
characterised in that a first fibre rope section (4a) of a first length is connected to the object (14) via a first connector (3a) on the object before the lowering is started and is freely run out from a storage reel (13) during the descent and is subsequently supporting the object via a second connector (3b) located at the upper end of the first rope section (4a), the second connector being supported by a support mechanism (1) on the vessel (8), off-loading the crane wire (16) and disconnecting it from the object and heaving it up said first length for connection to the second connector (3b) at the vessel and taking over the load of the object, lowering the object (14) a second length into the water by the crane while a second rope section (4b) connected to the second connector is freely run out from a storage reel (13) until a third connector (3c) located at the upper end of the second rope supports the load of the object in the support mechanism (1), whereupon the crane hook can be released and be brought up for re-connection to the third connector (3c) for the subsequent deployment, and any further deployment by addition to the string of ropes, thereby allowing the object (14) to reach a depth of up to 3000 meter, or even more.

2. A method according to claim 1,
wherein the object (14) located on seabed in very deep water is retrieved onto the vessel by lifting the object by the crane (12) from the seabed onto the vessel by reversing the sequence of operations defined therein.

3. A method according to claim 2, wherein an accelerometer (23) located on the object (14) and connected to the heave compensated crane (12) acoustically or via a cable to an ROV or vessel, is monitoring any resonance behaviour of the rope sections (4) and object (14), especially prior to landing the object onto a deep water seabed location, in order to reduce and/or minimise the impact onto the object during the actual landing on seabed.

4. A method according to claim 1, wherein an accelerometer (23) located on the object (14) and connected to the heave compensated crane (12) acoustically or via a cable to an ROV or vessel, is monitoring any resonance behaviour of the rope sections (4) and object (14), especially prior to landing the object onto a deep water seabed location, in order to reduce and/or minimise the impact onto the object during the actual landing on seabed.

5. An apparatus for supporting the load of a submerged object (14) suspended from a vessel,
characterised in that said apparatus (1) comprises a suspension device which is arranged at or near one side of the vessel (8) and is provided with a hang-off cradle (2) capable of supporting a connector (3) connected to at least one fibre rope section (4a,b) for carrying the load of the object (14).

6. An apparatus according to claim 5,
wherein the cradle has a vertical cut facing away from the side of the vessel to allow the rope (4a,b) to enter sideways into the cradle for subsequent lowering of the connector into the cradle (2) for supporting the load of the object (14).

7. An apparatus according to claim 6,
wherein the connector is a roundel (3) which has a number of holes along the circumference enabling rope sections (4a,b) to be connected via thimbles (5) and the crane hook (11) to be connected via a shackle (7) and grommet (6).

8. An apparatus according to claim 6,
wherein the cradle (2) has a vertical motion compensation system.

9. An apparatus according to claim 6,
wherein the connector is a roundel (3) made from plate material.

10. An apparatus according to claim 8,
wherein said system comprises an elevator tower (17) with two sheaves (19) which is allowing a wire line (18) from a passive heave compensator on the deck (8) of the vessel to be connected to, suspend and guide the cradle (2), which is fitted with guide-shoes (21), along the elevator guides (22) on one side of the tower (17) with a vertical stroke of 2-3 meter when the connector (3) with the load of the object (14) is being supported by the cradle (2), thereby allowing the connector to move vertically and mitigate the heave of the vessel and avoid slack in the ropes (4a,b) and particularly avoid any snap loads while the connector is supported by the cradle (2).

11. An apparatus according to claim 5,
wherein the suspension device has a vertical motion compensation system comprising an elevator tower (17) with two sheaves (19) which is allowing a wire line (18) from a passive heave compensator on the vessel to be connected to said connector (3), the connector being guided on one side of the tower (17) with a vertical stroke of 2-3 meter when the connector (3) is supporting the object (14),
thereby allowing the connector to move vertically and mitigate the heave of the vessel and avoid slack in the ropes (4a,b) and any snap loads.

12. An apparatus according to claim 5,
wherein the connector is a roundel (3) which has a number of holes along the circumference enabling rope sections (4a,b) to be connected via thimbles (5) and the crane hook (11) to be connected via a shackle (7) and grommet (6).

13. An apparatus according to claim 5,
wherein the cradle (2) has a vertical motion compensation system.

14. An apparatus according to claim 5,
wherein the connector is a roundel (3) made from plate material.
